(19) United States
(12) Patent Application Publication
(10) Pub. No.: US 2024/0365803 A1
(43) Pub. Date: Nov. 7, 2024

(54) AUTOMATED UNIT FOR THE ON-FARM PRODUCTION OF MULTIPLE ON-DEMAND DAIRY PRODUCTS

(71) Applicant: FAIRME, Le Versoud (FR)

(72) Inventors: Loïc LECERF, Meylan (FR); Quentin MARGEOT, Saint-Médard-en-Jalles (FR)

(21) Appl. No.: 18/292,802

(22) PCT Filed: Aug. 5, 2022
(86) PCT No.: PCT/FR2022/051564

§ 371 Date: Jan. 26, 2024

(30) Foreign Application Priority Data
Aug. 11, 2021 (FR) FR2108639

(51) Int. Cl. A23C 9/12; B25J 11/00

(52) U.S. Cl. CPC A23C 9/122; B25J 11/0045

(57) ABSTRACT

The disclosure relates to a method of automated on-farm production of a plurality of types of dairy products on demand, comprising the automated steps of receiving an electronic order for a dairy product from a consumer; filling a tank with milk directly from milking; filling a batch of containers from the tank; passing the batch of containers through at least one processing module configured to apply a processing step adapted to the dairy product ordered; storing the processed contents of the batch of containers in a controlled-atmosphere module; and on request from the consumer on site, conditioning the processed contents of the batch of containers in a form suitable for presentation to the consumer.

### CROSS REFERENCES TO RELATED APPLICATIONS

This application is a 371 of International Application No. PCT/FR2022/051564, filed Aug. 5, 2022, which claims priority to French Patent Application No. FR2108639, filed Aug. 11, 2021, the disclosures of which are herein incorporated by reference in their entirety.

### TECHNICAL FIELD

The disclosure relates to the automated production of dairy products, and more particularly to small-scale production.

### BACKGROUND

Dairies use large-scale industrial processes to produce a whole range of dairy products ready for supermarkets. Dairies are generally located at a distance from production farms, and are supplied with raw milk by refrigerated tanker trucks which collect the milk from the farms.

Dairy products from local production involve essentially manual processes, as industrial processes are not suited to the small quantities produced by individual farms.

Many dairy farmers give up local production because they don't have the time to devote to the essentially manual processes involved.

### SUMMARY

An automated production unit for a plurality of types of dairy products on demand is generally provided, including a tank for receiving raw milk directly from milking; a tray handling robot configured to move longitudinally in a service aisle; arranged at the edge of the aisle, a plurality of processing modules having guides configured to receive trays transferred transversely by the handling robot. The modules include a tray storage module; a container storage module, configured to receive a tray transferred by the robot from the tray storage module, and to arrange containers on the tray; a filling module, configured to receive a tray transferred by the robot from the container storage module, and to fill the containers from the receiving tank; and at least one main processing module, configured to receive a tray transferred by the robot from the filling module, and apply a processing step adapted to a dairy product requested by a consumer.

The production unit may further comprise a conditioning module configured to receive a tray transferred by the robot at the end of a cycle, and retrieve finished products conveyed on the tray to make them available to the consumer in suitable packaging.

The tray storage module may also be configured to wash the trays.

The production unit may comprise a controlled-atmosphere module configured to receive and maintain a tray transferred by the robot from the main processing module pending transfer of the tray to the conditioning module, the robot being programmed to transfer the tray to the conditioning module at an on-site request of the consumer.

The receiving tank may be configured to perform a pasteurization, curdling or turbinating function depending on the type of dairy product requested, the production unit comprising an input distribution unit, configured to dose the tank contents with an additive specific to the type of dairy product requested.

The main processing module may comprise a heating module.

The main processing module may comprise a straining module or a pressing module.

The controlled-atmosphere module may comprise a refrigeration module, a freezing module or a maturation cellar.

The container storage and filling modules may each comprise a CNC machine for, respectively, positioning the containers individually on the tray and moving a dairy product dosing nozzle from container to container.

The production unit may be entirely enclosed in a transportable shelter.

A method of automated on-farm production of a plurality of types of dairy products on demand is also provided, comprising the automated steps of receiving an electronic order for a dairy product from a consumer; filling a tank with milk directly from milking; filling a batch of containers from the tank; passing the batch of containers through at least one processing module configured to apply a processing step adapted to the dairy product ordered; storing the processed contents of the batch of containers in a controlled-atmosphere module; and on request from the consumer on site, conditioning the processed contents of the batch of containers in a form suitable for presentation to the consumer.

### BRIEF DESCRIPTION OF THE DRAWINGS

The following non-limiting description is provided in relation to the attached figures, which include:

FIG. 1 shows a schematic top view of a small-scale automated dairy production unit;

FIG. 2 is a perspective view of a tray-handling robot; and

FIG. 3 is a perspective view of a filling module of the production unit.

### DETAILED DESCRIPTION

The methods described below are aimed at local, small-scale, fully automated production of dairy products. Production is ensured by a production unit preferably entirely contained in a transportable enclosed shelter, for example a shipping container, which is installed on site at the milk producer's farm. The production unit can thus be supplied directly with milk from the milking in the farm, ensuring optimum raw milk quality.

The small scale of the automated production opens up a number of possibilities that are difficult to achieve with a large-scale production. In particular, the production unit can operate on demand, i.e. take an electronic order from a consumer, organize production, and deliver the product when the consumer comes on site.

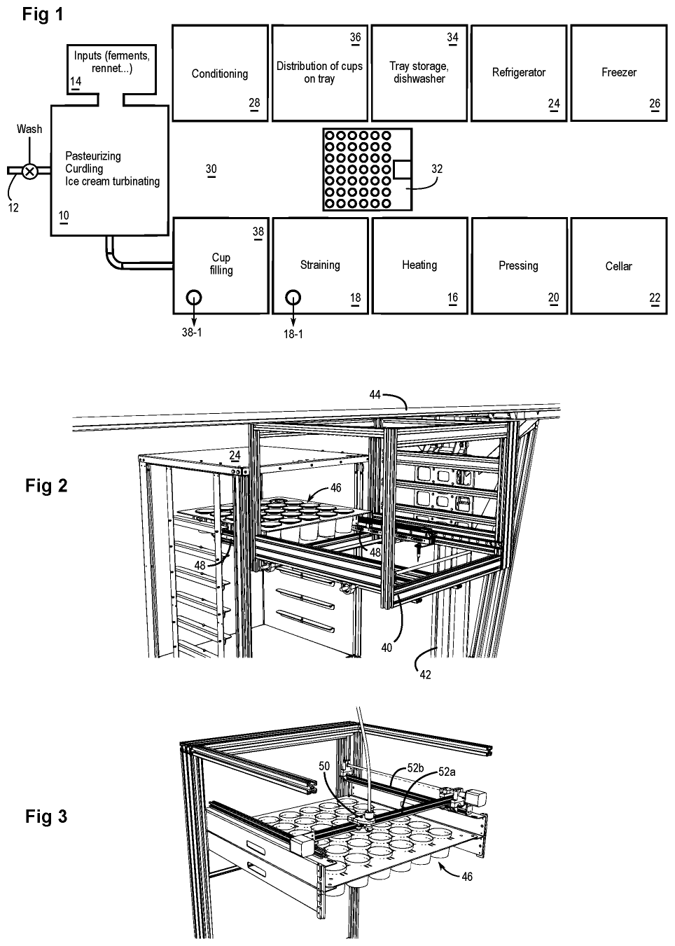

FIG. 1 shows a top view of an embodiment of such production unit. The unit comprises a receiving tank 10 fed by a pipe 12. When the unit is placed at the farm, pipe 12 may be connected to receive milk directly from milking.

Tank 10 may be a single tank, configured to carry out several possible pretreatments, depending on the dairy products to be produced, including pasteurization, curdling, or turbinating ice cream. Alternatively, several tanks 10 may be provided, each carrying out a different pretreatment, allowing different batches of dairy products to be started in parallel.

An input dispenser 14 is connected to tank 10 to dose various additives required by the dairy product being manufactured, such as ferments for yoghurt and cheese, rennet for cheese, and ingredients for ice cream.

Several processing modules are installed around tank 10, each designed to perform one or more steps in the dairy product manufacturing process. The unit comprises, for example, a heating module 16 for making yoghurts, a straining module 18 for making different types of cheese, a pressing module 20 for making pressed cheeses, and several controlled-atmosphere modules 22, 24, 26. Module 22 reproduces the conditions of a maturation cellar, module 24 is a refrigerator, and module 26 is a freezer. A conditioning module 28 is provided to offer the finalized dairy product in a ready-to-carry package, for example several cups arranged in a parcel.

The modules described above carry out well-known steps in dairy product manufacturing processes, and it is known how to automate them. The main difficulty in the automation lies in transporting dairy products from one step to the next.

To ensure the transport of dairy products in the production unit described here, with a view to small-scale production, all the modules are organized along a service aisle 30 in which a handling robot 32 moves.

It is provided to transport the dairy products in cups as soon as they leave tank 10. The cups are adapted to the manufacturing process of the requested dairy product. The cups are arranged on corresponding trays, which the robot 32 transfers from one module to another according to the manufacturing process required by the requested dairy product. Each module is designed to receive one or more trays in guides.

Three additional modules are designed to handle the transport of cups on trays. Module 34 stores the trays in guides, and also acts as a dishwasher to wash trays returning from a production cycle.

A module 36 stores new cups and dispenses them onto a tray presented to it. The new cups, made of flexible material, may be stacked between parallel tubes which hold the cups in place by friction. A CNC (“Computer Numerical Control”) machine may be configured to pick up each cup by suction or gripping and deposit it in an available hole in the tray. New cups are preferably stored above the tray, with their opening facing downwards, so that the machine pulls each cup from its inside from the bottom of the stack, turns it around, and deposits it on the tray.

A module 38 is configured to fill the cups of a tray presented to it. It may comprise a dosing nozzle connected to the tank 10, which is mobilized by a CNC machine to fill the cups one after the other.

Preferably, as shown, the modules are built in cabinets of the same dimensions, so as to be interchangeable, and are arranged on either side of aisle 30. Although a spatial organization of individual modules has been depicted, several modules may in fact be incorporated into the same cabinet, or even merged with other modules. For example, the pressing performed by module 20 may simply be an extension of the straining performed by module 18, since pressing is simply an accelerated straining operation.

FIG. 2 is a partial perspective view of an embodiment of the handling robot 32. The robot comprises a parallelepiped carriage 40 which slides vertically on a beam 42. One end of beam 42 slides on a rail 44 in the axis of the service aisle. Preferably, as shown, the rail 44 is located overhead rather than on the ground. The carriage 40 has a length slightly less than the width of the aisle, a width slightly less than the width of the modules, and a height suitable for providing satisfactory rigidity.

The carriage is shown depositing a tray fitted with cups 46 on guides in the upper part of one of the modules, for example the refrigeration module 24. To handle the trays, the carriage comprises a pair of transverse telescopic arms 48, on which two opposite edges of a tray can be supported. The arms are configured to fully extend or retract a tray on either side of the carriage, in order to deposit or retrieve the tray in a module located on either side of the aisle. The actions of lifting or depositing a tray are ensured by a vertical movement of the carriage along beam 42.

More specifically, a tray is transferred from one module to another as follows. The beam 42 slides longitudinally along the rail 44 until the carriage 40 is aligned with the module where the tray is to be retrieved. The carriage is moved vertically along beam 42 until telescopic arms 48 are slightly below the tray to be retrieved. The arms 48 are extended and enter the module beneath the tray. The carriage is raised along beam 42 to lift the tray sufficiently off its guides. The telescopic arms are retracted, retracting the tray to the center of the carriage.

Beam 42 then slides until carriage 40 is aligned with the module where the tray is to be deposited. The carriage is moved vertically along the beam 42 until the telescopic arms 48 are slightly above the guides where the tray is to be deposited. The arms 48 are extended into the module, presenting the tray above the guides. The carriage is lowered along beam 42 to deposit the tray on its guides. The telescopic arms are retracted to start a new transfer operation.

Some of the modules are normally closed to perform their function, notably the atmosphere-controlled modules. To enable trays to be transferred, these modules are closed by a top and bottom half-door which slide vertically—to open the bottom half of the module, the bottom half-door is raised to overlap with the top half-door, and to open the top half of the module, the top half-door is lowered to overlap with the bottom half-door.

FIG. 3 is a perspective view of a cup-filling module 38. The tray with its cups 46 is placed on guides. To ensure relatively precise positioning, the tray may be fitted, as shown, with holes at its corners, which fit over cones on the guides. The cups are individually filled from the tank 10 by a dosing nozzle 50 moved by a CNC machine with two axes 52a, 52b. Of course, the type of tray and the positions of the cups on the tray are known to the machine. Indeed, a centralized control system may be configured to track each tray and thus know at all times which type of tray is in which module and at which position. Alternatively, the trays may convey an identifier, such as a barcode, which is read at the entrance to each module.

As shown, the cup-receiving apertures of tray 46 have notches at their circumference. These notches enable a robotic gripper to extract the cups in a subsequent processing module, such as the conditioning module28.

With reference to FIG. 1, some examples of processes for manufacturing different dairy products are described below, in a non-exhaustive way, and some more detailed examples of the operation of certain modules are presented.

As previously mentioned, a consumer may place an order for dairy products electronically, for example on a website, using a mobile application, or using an on-site display. The order may include dairy products of different types. The system then proposes delivery dates according to its stock and/or production capacity.

To make yoghurt, for example, tank 10 may be used in pasteurization mode. After pasteurization, the dispenser 14 adds yoghurt ferments. Module 38 receives a tray of empty cups and fills them from the contents of tank 10. After filling, the tray is transferred to heater 16.

After heating, the tray is transferred to refrigerator 24 to await the delivery date scheduled with the consumer. Before or after heating, the tray may pass through the conditioning module 28 to seal the cups.

On the delivery date, the consumer visits the production unit and requests the order, for example by entering a code on an interface, or using a mobile application. The tray of yoghurt cups is then removed from the refrigerator and transferred to the conditioning module 28, where the cups corresponding to the order are placed in a parcel along with any other products ordered. The package may be presented to the consumer through a hatch.

The empty tray is returned to the storage module/dishwasher 34, where it will be washed when a sufficient number of empty trays have been returned or when the stock of clean trays is insufficient.

Alternatively, to release the tray immediately, the yoghurt cups may be packaged in 28 as soon as they come out of the heater, in which case the package is transferred to the refrigerator to await delivery, while the tray is returned to the dishwasher.

For cheese production, tank 10 may be used in curdling-only mode for raw milk cheese, or in pasteurization and curdling mode. The dispenser 14 adds ferments and rennet at the appropriate time and temperature, depending on the processing technology specific to each cheese category.

For example, in the case of a lactic curd, after 18 to 24 hours of curdling, the tray is fitted with microperforated molds suitable for straining the whey in module 36. The tray is then transferred to the straining module 18, where the curds continue to strain by gravity. The whey resulting from this straining process may be collected in a tank via a drain 18-1.

To prevent whey leaking into the aisle 30 during transfer, the tray may be fitted with a collection container attached to the underside of the tray. This container may be fitted with a drain mechanism that is activated when the container is inserted into the module, wherein module 18 is then configured so that the container contents flow into drain 18-1. This solution leaves module 18 clean and relaxes the cleaning constraints.

When the tray and its container are returned to the dishwasher, the draining mechanism of the container is also activated, to drain off any remaining whey and allow the wash water to circulate.

Alternatively, if leakage is permitted in aisle 30, the aisle may be cupped and fitted with a drain to evacuate run-off occurring during transfers. This is facilitated when the robot's transport rail is located overhead, thus clearing the aisle of any obstacles. The aisle may be cleaned regularly and automatically using jets. Steam may be used to disinfect the different volumes.

The recovered whey may be recycled. For example, the sweet whey from rennet-based coagulations may be returned to tank 10 for the production of whey cheeses such as Sérac or Ricotta by thermocoagulation.

After straining in 18, the tray generally undergoes further handling. Depending on the product to be obtained, the contents of the microperforated molds are i) decanted into cups (ready-to-eat cottage cheese), ii) turned in their molds for a second straining phase, or iii) removed from the molds. The required handling may be carried out by the robotic gripper available in module 36, in which module the tray is transferred after straining.

To facilitate handling, only half of the tray capacity may be occupied by cups or molds, while the other half of the tray is organized for the required handling. In this case, the robotic gripper has access to all locations on a single plane. For this purpose, the other half of the tray may i) have apertures to receive the cups for decanting, ii) have apertures to receive a series of microperforated molds for turning, or iii) be flat to receive the demolded contents. The empty microperforated molds may remain in place and be reused after the tray has been run through the dishwasher 34.

In case i), the cups contain ready-to-eat cottage cheese—the tray may be transferred to refrigerator 24 while awaiting delivery.

In case ii), the tray returns to the straining module 18. This two-stage straining process being generally used for salted cheeses, straining module 18 may be configured to surface-salt the cup contents during each of the two straining stages. Salting may be carried out using a CNC-mounted dosing unit.

After the second straining phase, the product is demolded, which then corresponds to case iii).

In case iii), after demolding, the tray is transferred to the maturation cellar 22.

After a programmed maturation period, the tray can be transferred to refrigerator 24 to await delivery.

Demolded cheeses may be handled using a robotic spatula or a suction pad, for example, to pack them for delivery in 28.

In the case of pressed cheese, between straining in 18 and maturation in 22, the tray is transferred to the press module 20. The press module may comprise a series of pistons, the size of the cups, which exert a set pressure on the upper faces of the cheeses, for a programmed time.

The pressing extracts more whey, which falls into the collection container. Like in the straining module 18, the container drain mechanism is activated when the tray is inserted. The strained whey may be collected in a tank, from where it may be returned to the processing tank 10.

The straining module 18 and the pressing module 20 may form a single unit. If only straining is required, pressing is not activated. However, since the straining operation is relatively time-consuming, it is preferable to provide two separate modules to improve production rates.

As to sanitary aspects, the equipment needs to be washed regularly. As most of the steps in the manufacturing process are carried out here on dairy products conveyed in containers (cups, molds) or decanted in trays that are put through the dishwasher, there is little equipment to wash. In practice, it is sufficient to wash the circuit running from the inlet of tank 10 to the dosing nozzle of filling module 38. This may be done using a closed-circuit CIP (Clean In Place) system, with alternating alkaline phases (chlorinated alkaline solution) and acid phases, preceded and followed by rinsing with clean water, in pipe 12, tank 10 and up to the dosing nozzle of module 38. During washing, the dosing nozzle may be positioned above a drain 38-1.

1. An automated production unit for a plurality of types of dairy products on demand, the automated production unit including:
a tank for receiving raw milk directly from milking;
a tray handling robot configured to move longitudinally in a service aisle;
arranged at an edge of the service aisle, a plurality of processing modules having guides configured to receive trays transferred transversely by the robot, including:
a tray storage module;
a container storage module, configured to receive a tray transferred by the robot from the tray storage module, and to arrange containers on the tray;
a filling module, configured to receive the tray transferred by the robot from the container storage module, and to fill the containers from the tank; and
at least one main processing module, configured to receive the tray transferred by the robot from the filling module, and apply a processing step adapted to a dairy product requested by a consumer.

2. The production unit according to claim 1, further comprising a conditioning module configured to receive a tray transferred by the robot at an end of a cycle, and retrieve finished products conveyed on the tray to make them available to the consumer in suitable packaging.

3. The production unit according to claim 1, wherein the tray storage module is also configured to wash the trays.

4. The production unit according to claim 2, comprising a controlled-atmosphere module configured to receive and maintain the tray transferred by the robot from the main processing module pending transfer of the tray to the conditioning module, the robot being programmed to transfer the tray to the conditioning module at an on-site request of the consumer.

5. The production unit according to claim 1, wherein the tank is configured to perform a pasteurization, curdling or turbinating function depending on the type of dairy product requested, the production unit comprising an input distribution unit, configured to dose contents of the tank with an additive specific to the type of dairy product requested.

6. The production unit according to claim 5, wherein the main processing module comprises a heating module.

7. The production unit according to claim 5, wherein the main processing module comprises a straining module or a pressing module.

8. The production unit according to claim 4, wherein the controlled-atmosphere module comprises a refrigeration module, a freezing module or a maturation cellar.

9. The production unit according to claim 1, wherein the container storage and filling modules each comprise a CNC machine for, respectively, individually positioning the containers on the tray and moving a dairy product dosing nozzle from container to container.

10. The production unit according to claim 1, entirely enclosed in a transportable shelter.

11. A method of automated on-farm production of a plurality of types of dairy products on demand, comprising the following automated steps:
receiving an electronic order for a dairy product from a consumer;
filling a tank with milk directly from milking;
filling a batch of containers from the tank;
passing the batch of containers through at least one processing module configured to apply a processing step adapted to the dairy product ordered;
storing the processed contents of the batch of containers in a controlled-atmosphere module; and
on request from the consumer on site, conditioning the processed contents of the batch of containers in a form suitable for presentation to the consumer.
